(19) United States
(12) Patent Application Publication
(10) Pub. No.: US 2025/0191099 A1
(43) Pub. Date: Jun. 12, 2025

(54) TRAFFIC MANAGEMENT APPARATUS, TRAFFIC MANAGEMENT SYSTEM, TRAFFIC MANAGEMENT METHOD, AND NON-TRANSITORY COMPUTER READABLE MEDIUM

(71) Applicant: NEC Corporation, Minato-ku, Tokyo (JP)

(72) Inventor: Kosei Kobayashi, Tokyo (JP)

(73) Assignee: NEC Corporation, Minato-ku, Tokyo (JP)

(21) Appl. No.: 18/844,454

(22) PCT Filed: Mar. 18, 2022
(86) PCT No.: PCT/JP2022/012795

§ 371 Date: Sep. 6, 2024

(51) Int. Cl. G06Q 50/40; G01M 15/10; G06Q 30/018

(52) U.S. Cl. CPC G06Q 50/40; G01M 15/102; G06Q 30/018; G06Q 2240/00

(57) ABSTRACT

A traffic management apparatus (102) includes an estimation unit (103) and a decision unit (104). The estimation unit (103) estimates an exhaust gas amount of a vehicle. The decision unit (104) decides a toll fee for a target vehicle to pass through a predetermined road section, by using the exhaust gas amount being estimated.

### TECHNICAL FIELD

The present invention relates to a traffic management apparatus, a traffic management system, a traffic management method, and a storage medium.

### BACKGROUND ART

Patent Document 1 describes a technique for computing an emission amount Z2 of carbon dioxide (carbon dioxide emission amount) being excessively discharged due to traffic congestion.

Patent Document 2 describes that a CO₂ emission amount estimation model is established based on the following concepts.

A. With regard to a census section, a traffic volume for all time periods over 365 days, that is, 8,760 hours in total, is estimated, and travel velocity-specific vehicle kilometers are estimated for each time period by using a QV formula. Note that, it is described that the Q-V formula is set based on road traffic census data specific to a road type, the number of lanes, an urban area or a non-urban area, a traffic light density, and a congestion state or a non-congestion state.

B. A CO₂ emission amount is output via an emission basic unit specific to a travel velocity.

C. With regard to a municipal road, regardless of a congestion level, a travel velocity is set to 18 km/h in an urban area, and is set to 28 km/h in a non-urban area (a value being an average travel velocity during congestion for a general prefectural road), and a CO₂ emission amount is estimated.

Patent Document 3 describes a technique for estimating a traffic volume.

Non-Patent Document 1 describes a technique for estimating a carbon dioxide emission amount.

### RELATED DOCUMENT

### Patent Document

Patent Document 1: International Patent Publication No. WO2020/065972
Patent Document 2: Japanese Patent Application Publication No. 2007-328769
Patent Document 3: Japanese Patent Application Publication No. 2018-055455

### Non-Patent Document

Non-Patent Document 1: Tetsuhiro ISHIZAKA et al., “Review and Application of CO₂ Emission Estimation Method for Automobile Traffic” [Online], [Searched on Dec. 20, 2021], Internet <URL: http://library.jsce.or.jp/jsce/open/00039/200906_no39/pdf/35.pdf>

### DISCLOSURE OF THE INVENTION

### Technical Problem

However, even when a carbon dioxide emission amount can be estimated by using the techniques described in Patent Documents 1 and 2 and Non-Patent Document 1, it is difficult to reduce an exhaust gas amount. Even when a traffic volume can be estimated by using the technique described in Patent Document 3, it is difficult to reduce an exhaust gas amount.

In view of the above-mentioned problem, one example of an object of the present invention is to provide a traffic management apparatus, a traffic management system, a traffic management method, and a storage medium that solve reducing an exhaust gas amount.

### Solution to Problem

According to one aspect of the present invention, there is provided a traffic management apparatus including:
an estimation unit that estimates an exhaust gas amount of a vehicle; and
a decision unit that decides a toll fee for a target vehicle to pass through a predetermined road section, by using the exhaust gas amount being estimated.

According to one aspect of the present invention, there is provided a traffic management system including:
the traffic management apparatus described above; and
a generation apparatus that generates information for estimating an exhaust gas amount of the vehicle.

According to one aspect of the present invention, there is provided a traffic management method including,
by a computer:
   estimating an exhaust gas amount of a vehicle; and
   deciding a toll fee for a target vehicle to pass through a predetermined road section, by using the exhaust gas amount being estimated.

According to one aspect of the present invention, there is provided a storage medium storing a program for causing a computer to execute:
estimating an exhaust gas amount of a vehicle; and
deciding a toll fee for a target vehicle to pass through a predetermined road section, by using the exhaust gas amount being estimated.

### Advantageous Effects of Invention

According to the present invention, an exhaust gas amount can be reduced.

### BRIEF DESCRIPTION OF THE DRAWINGS

FIG. 1 is a diagram illustrating an overview of a traffic management system according to an example embodiment 1 of the present invention.

FIG. 2 is a diagram illustrating an overview of traffic management processing according to the example embodiment 1 of the present invention.

FIG. 3 is a diagram of a road R at a time T1 as viewed from above.

FIG. 4 is a diagram illustrating one example of a physical configuration of a generation apparatus according to the example embodiment 1 of the present invention.

FIG. 5 is a diagram illustrating one example of a physical configuration of a traffic management apparatus according to the example embodiment 1 of the present invention.

FIG. 6 is a flowchart illustrating one example of generation processing according to the example embodiment 1 of the present invention.

FIG. 7 is a flowchart illustrating one example of details of the traffic management processing according to the example embodiment 1.

FIG. 8 is a flowchart illustrating one example of details of estimation processing according to the example embodiment 1.

FIG. 9 is a flowchart illustrating one example of details of analysis processing according to the example embodiment 1.

FIG. 10 is a diagram illustrating one example of a result of an analysis by an analysis model according to the example embodiment 1, where images included in image information PI_i at the time T1 and a time T2, and the image information PI_i at the time T1 and the time T2 are used as input data.

FIG. 11 is a diagram illustrating one example of an analysis result according to the example embodiment 1.

FIG. 12 is a diagram illustrating one example of an estimation result for each region according to the example embodiment 1.

FIG. 13 is a diagram illustrating one example of an estimation result for an entire road according to the example embodiment 1.

FIG. 14 is a diagram illustrating one example of a configuration of a traffic management system according to an example embodiment 2 of the present invention.

FIG. 15 is a flowchart illustrating one example of traffic management processing according to the example embodiment 2 of the present invention.

FIG. 16 is a flowchart illustrating one example of details of estimation processing according to the example embodiment 2.

FIG. 17 is a flowchart illustrating one example of details of analysis processing according to the example embodiment 2.

FIG. 18 is a diagram illustrating one example of a result of an analysis by an analysis model according to the example embodiment 2, where the images included in image information PI_i at the time T1 and the time T2, and the image information PI_i at the time T1 and the time T2 are used as input data.

FIG. 19 is a diagram illustrating one example of vehicle model data according to the example embodiment 2.

FIG. 20 is a diagram illustrating one example of an analysis result according to the example embodiment 2.

FIG. 21 is a diagram illustrating one example of a configuration of a traffic management system according to an example embodiment 3 of the present invention.

FIG. 22 is a diagram illustrating one example of a functional configuration of a traffic management apparatus according to the example embodiment 3 of the present invention.

FIG. 23 is a flowchart illustrating one example of traffic management processing according to the example embodiment 3 of the present invention.

### EXAMPLE EMBODIMENT

One example embodiment of the present invention is described below with reference to the drawings. Note that, in all the drawings, a similar constituent element is denoted with a similar reference sign, and description therefor is omitted as appropriate.

### Example Embodiment 1

### (Overview of Traffic Management System 100)

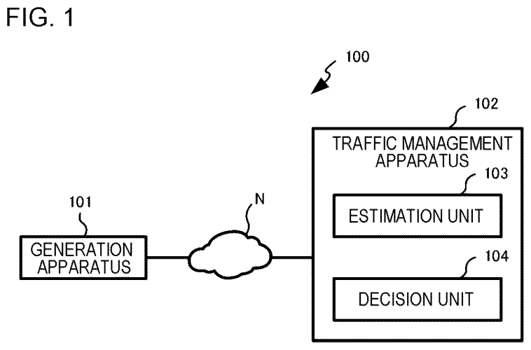

FIG. 1 is a diagram illustrating an overview of a traffic management system 100 according to an example embodiment 1 of the present invention. The traffic management system 100 includes a generation apparatus 101 and a traffic management apparatus 102.

The generation apparatus 101 generates information for estimating an exhaust gas amount of a vehicle.

The traffic management apparatus 102 includes an estimation unit 103, and a decision unit 104.

The estimation unit 103 estimates an exhaust gas amount of a vehicle. The decision unit 104 decides a toll fee for a target vehicle to pass through a predetermined road section, by using the exhaust gas amount being estimated.

### (Overview of Traffic Management Processing)

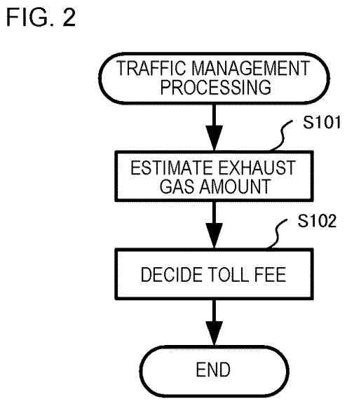

FIG. 2 is a diagram illustrating an overview of traffic management processing according to the present example embodiment.

The estimation unit 103 estimates an exhaust gas amount of a vehicle (step S101).

The decision unit 104 decides a toll fee for a target vehicle to pass through a predetermined road section, by using the exhaust gas amount being estimated (step S102).

According to the present example embodiment, an exhaust gas amount can be reduced.

Hereinafter, description is made on a detailed example of the traffic management system 100 according to the example embodiment 1.

### Details of Example Embodiment 1

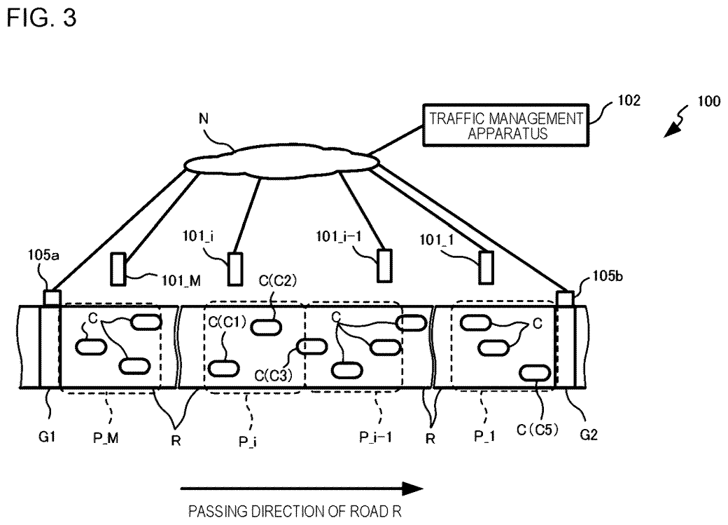

FIG. 3 is a diagram of a road R at a time T1 as viewed from above. The road R is a road extending from an entrance gate G1 to an exit gate G2. In the drawing, an example in which a plurality of vehicles C pass through the road is illustrated. Note that, the vehicle C may be one or more.

The road R is equivalent to road sections of the road R. The road R includes a plurality of target regions P_i that are set for a section along a passing direction of the road R. Target regions P_1 to P_M according to the present example embodiment are M virtual regions being acquired by dividing the entire road R from the entrance gate G1 to the exit gate G2 without an interval.

Herein, i is an integer equal to or greater than 1 and equal to or less than M. M is an integer equal to or greater than 2. Those similarly apply to the following description.

Note that, the target region P may be one. One or a plurality of target regions P may be set on a part of the road R. A plurality of target regions P may be set on the road R at an interval.

In detail, as illustrated in the drawing, the traffic management system 100 includes a plurality of generation apparatuses 101_1 to 101_M that are associated with the target regions P_1 to P_M, respectively, the traffic management apparatus 102, an ID acquisition apparatus 105a, and a settlement apparatus 105b. Each of the generation apparatuses 101_1 to 101_M, the ID acquisition apparatus 105a, and the settlement apparatus 105b is a facility installed on the road R.

Each of the generation apparatuses 101_1 to 101_M, the ID acquisition apparatus 105a, and the settlement apparatus 105b is connected to the traffic management apparatus 102 via a network N. The network N is a communication network being wired, wireless, or a combination thereof.

Thus, each of the generation apparatuses 101_1 to 101_M and the traffic management apparatus 102 can transmit and receive information mutually. The ID acquisition apparatus 105a and the traffic management apparatus 102 can transmit and receive information mutually. The settlement apparatus 105b and the traffic management apparatus 102 can transmit and receive information mutually.

The generation apparatus 101_i photographs the target region P_i. In response to photographing, the generation apparatus 101_i generates image information PI_i including an image of the target region P_i. In other words, the image information PI_i is information being acquired in response to photographing of the road R. In a case where one or more vehicles C pass through the road R, the image information PI_i includes the one or more vehicles C.

The image information PI_i according to the present example embodiment further includes a photographing time.

The generation apparatus 101_i successively transmits the image information PI_i to the traffic management apparatus 102 via the network N in real time.

The “generation apparatus 101” (see FIG. 1) described above is equivalent to any one of the generation apparatuses 101_1 to 101_M (in other words, the generation apparatus 101_i). Note that, one target region P may be provided as described above, and one generation apparatus 101 may be provided in such a case.

The ID acquisition apparatus 105a is an apparatus that detects the vehicle C entering the road R. The ID acquisition apparatus 105a is installed at the entrance gate G1.

The ID acquisition apparatus 105a communicates wirelessly with an on-board device (omitted in illustration) mounted on the vehicle C. For example, the on-board device is an apparatus that configures an electronic toll collection system (ETC) together with the ID acquisition apparatus 105a, the settlement apparatus 105b, and the like.

Through the communication with the on-board device, the ID acquisition apparatus 105a detects the vehicle C entering the road R, and also acquires a vehicle identifier (ID) from the on-board device. The vehicle ID is information for identifying the vehicle C. The ID acquisition apparatus 105a transmits the acquired vehicle ID to the traffic management apparatus 102 via the network N.

The settlement apparatus 105b is an apparatus that detects the vehicle C exiting from the road R and also settles a toll fee for the vehicle C being detected, as a target vehicle, to pass through the road R.

In the present example embodiment, the settlement apparatus 105b is installed at the exit gate G2. At timing at which the vehicle C exits from the road R, the settlement apparatus 105b communicates with the vehicle C and the traffic management apparatus 102. Then, the settlement apparatus 105b performs settlement the toll fee for the target vehicle according to the toll fee being decided by the traffic management apparatus 102.

While the vehicle C passing through the exit gate G2 to which the settlement apparatus 105b is provided is regarded as the target vehicle, the traffic management apparatus 102 decides the toll fee for the target vehicle to pass through the road R.

The estimation unit 103 acquires the image information PI_i from each of the generation apparatuses 101_i via the network N. The estimation unit 103 estimates an exhaust gas amount of the vehicle C by using the image information PI_i being acquired from the generation apparatus 101_i. In other words, pieces of the image information PI_1 to PI_M according to the present example embodiment are one example of information for estimating the exhaust gas amount of the vehicle C.

Note that, the information for estimating the exhaust gas amount of the vehicle C is not limited to image information, and may be sensor information including a concentration of the exhaust gas (e.g., specific component gas contained in the exhaust gas, such as carbon dioxide) in the target region P, for example. In this case, each of the generation apparatuses 101_i may include a sensor that measures a concentration of the exhaust gas in the target region, and generate sensor information including an exhaust gas concentration. The estimation unit 103 may acquire the sensor information from each of the generation apparatuses 101_i via the network N, and estimate the exhaust gas amount of the vehicle C by using the sensor information.

For example, the exhaust gas amount of the vehicle C is an amount of carbon dioxide (CO₂) discharged from the vehicle C passing through the road R. Note that, the exhaust gas amount is not limited to an amount of carbon dioxide (CO₂). For example, the exhaust gas amount may be an amount of the entire exhaust gas from the vehicle C, or may be an amount of specific component gas in the exhaust gas from the vehicle C. As the specific component gas, greenhouse gas is suitable. CO₂ is one example of the greenhouse gas.

The decision unit 104 decides the toll fee for the target vehicle to pass through the road R, by using the exhaust gas amount being estimated by the estimation unit 103. The target vehicle is the vehicle C being a target for which the decision unit 104 decides a passing amount. The decision unit 104 transmits the toll fee for the target vehicle to the settlement apparatus 105b via the network N.

In the present example embodiment, as described above, the settlement apparatus 105b settles the toll fee at timing at which the vehicle C exits from the road R. Thus, the target vehicle is the vehicle C passing through the exit gate G2 to which the settlement apparatus 105b is provided. In other words, in the present example embodiment, at timing of passing through the exit gate G2, each of the vehicles C passing through the road R is regarded as the target vehicle.

### (Physical Configuration of Traffic Management System 100)

The traffic management system 100 is configured by the generation apparatus 101_i and the traffic management apparatus 102 that are connected to each other via the network N, in a physical sense. Each of the generation apparatus 101_i and the traffic management apparatus 102 is configured by single apparatus being different from each other in a physical sense.

Note that, the generation apparatus 101_i and the traffic management apparatus 102 may be configured by a single apparatus in a physical sense, and the generation apparatus 101_i and the traffic management apparatus 102 are connected to each other by using an internal bus 1010, which is described later, instead of the network N in such a case. Further, one or both of the generation apparatus 101_i and the traffic management apparatus 102 may be configured by a plurality of apparatuses that are connected to each other via an appropriate communication line, such as the network N, in a physical sense.

### (Physical Configuration of Generation Apparatus 101_i)

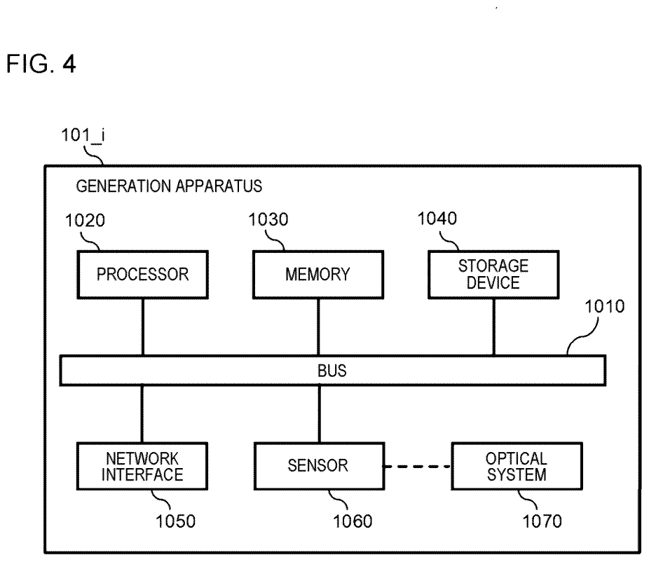

For example, the generation apparatus 101_i is a photographing apparatus such as a camera, in a physical sense. As illustrated in FIG. 4, the generation apparatus 101_i includes a bus 1010, a processor 1020, a memory 1030, a storage device 1040, a network interface 1050, a sensor 1060, and an optical system 1070.

The bus 1010 is a data transmission path in which the processor 1020, the memory 1030, the storage device 1040, the network interface 1050, and the sensor 1060 transmit and receive data mutually. However, a method of connecting the processor 1020 and the like to one another is not limited to bus connection.

The processor 1020 is a processor achieved by a central processing unit (CPU), a graphics processing unit (GPU), or the like.

The memory 1030 is a main storage apparatus achieved by a random access memory (RAM), or the like.

The storage device 1040 is an auxiliary storage apparatus achieved by a hard disk drive (HDD), a solid state drive (SSD), a memory card, a read only memory (ROM), or the like. The storage device 1040 stores a program module for achieving a function unit of the generation apparatus 101. The processor 1020 reads each of the program modules on the memory 1030 and executes the read program module, and thereby each of the functions associated with each of the program modules is achieved.

The network interface 1050 is an interface for connecting the generation apparatus 101 to the network N.

The sensor 1060 is an image sensor that converts an image into an electric signal. The optical system 1070 is a lens being used together with the sensor 1060, or the like.

### (Physical Configuration of Traffic Management Apparatus 102)

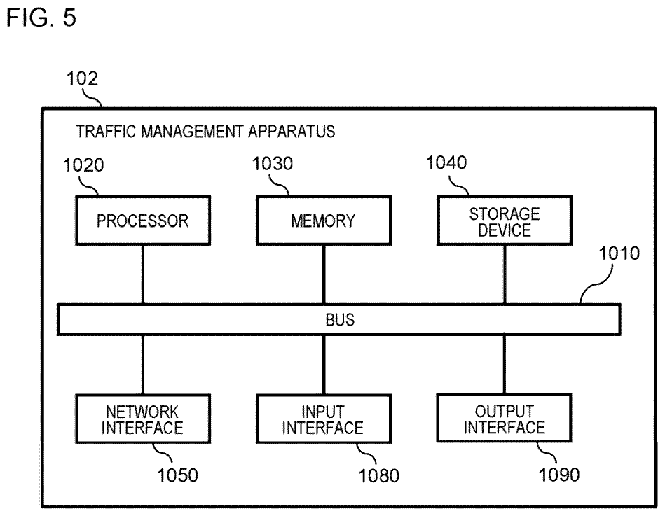

For example, the traffic management apparatus 102 is a general-purpose computer, in a physical sense. Similarly to the generation apparatus 101, as illustrated in FIG. 5, the traffic management apparatus 102 includes a bus 1010, a processor 1020, a memory 1030, a storage device 1040, and a network interface 1050. The traffic management apparatus 102 further includes an input interface 1080 and an output interface 1090.

For example, the input interface 1080 is an interface for inputting information by a user, and is configured, for example, by a touch panel, a keyboard, a mouse, or the like. The output interface 1090 is an interface for providing information to a user, and is configured, for example, by a liquid crystal panel, an organic electro-luminescence (EL) panel, or the like.

For example, in addition to the configuration included in the traffic management apparatus 102, each of the ID acquisition apparatus 105a and the settlement apparatus 105b includes a communication interface for communicating with the on-board device (omitted in illustration), in a physical sense.

### (Operation of Traffic Management System 100)

Hereinafter, operation of the traffic management system 100 is described with reference to the drawings.

### Generation Processing According to Example Embodiment 1

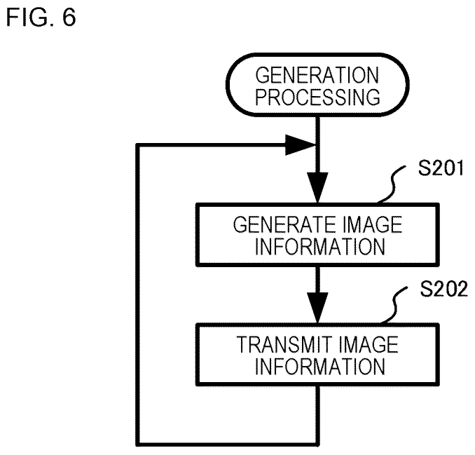

FIG. 6 is a flowchart illustrating one example of generation processing according to the present example embodiment. The generation processing is processing of generating information for estimating an exhaust gas amount of a vehicle. Each of the generation apparatuses 101_1 to 101_M executes the generation processing during the operation in a repeated manner.

The generation apparatus 101_i photographs the target region P_i, and then generates the image information PI_i including an image of the target region P_i in response to photographing thereof (step S201). The generation apparatus 101_i transmits the image information PI_i being generated in step S201 to the traffic management apparatus 102 via the network N (step S202). The generation apparatus 101_i executes step S201 again.

Each of the generation apparatuses 101_1 to 101_M executes the generation processing described above in a repeated manner. As a result, the generation apparatuses 101_1 to 101_M successively transmit the pieces of image information PI_1 to PI_M including images of the target regions P_1 to P_M associated therewith, respectively, to the traffic management apparatus 102 in real time.

### Traffic Management Processing According to Example Embodiment 1

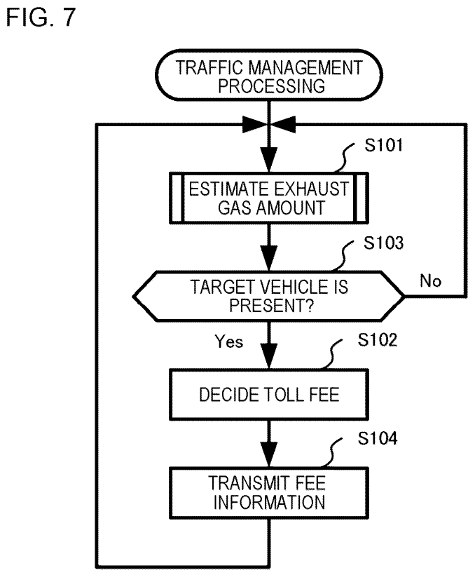

FIG. 7 is a flowchart illustrating one example of details of traffic management processing according to the present example embodiment. The traffic management apparatus 102 executes the traffic management processing during the operation in a repeated manner.

Typically, the road R is a toll road. However, the road R may be a road being usually free to pass therethrough. In this case, according to an instruction from a user, for example, in a case where an exhaust gas amount from the road R exceeds a threshold value, or the like, the traffic management apparatus 102 may start the traffic management processing. Further, according to an instruction from a user, the traffic management apparatus 102 may terminate the traffic management processing.

The estimation unit 103 estimates an exhaust gas amount of a vehicle by using the pieces of image information PI_1 to PI_M (step S101).

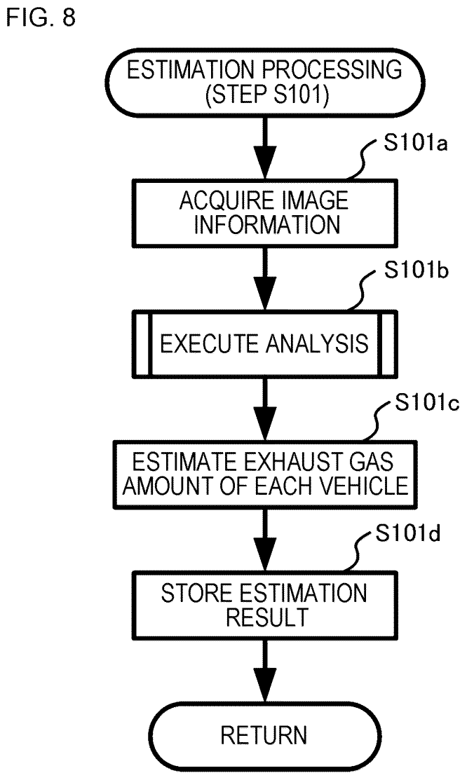

FIG. 8 is a flowchart illustrating one example of details of estimation processing (step S101).

The estimation unit 103 acquires the pieces of image information PI_1 to PI_M from the generation apparatuses 101_1 to 101_M, respectively, via the network N (step S101a). The estimation unit 103 stores the pieces of image information PI_1 to PI_M being acquired.

The estimation unit 103 analyzes the pieces of image information PI_1 to PI_M being acquired in step S101 (step S101b).

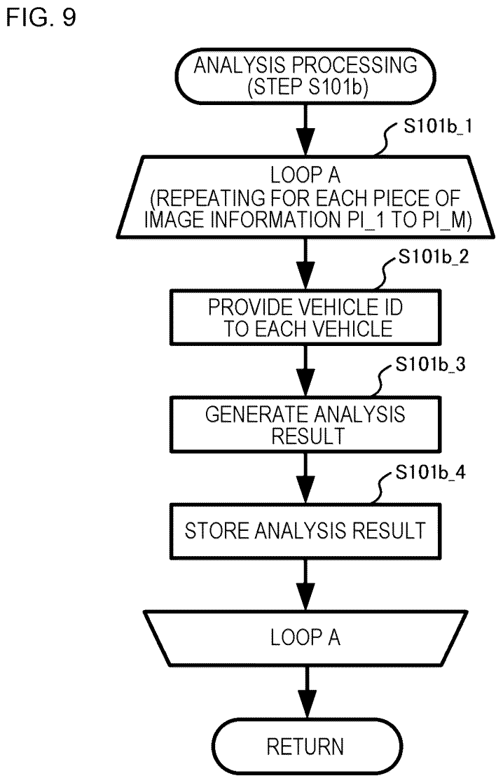

FIG. 9 is a flowchart illustrating one example of details of analysis processing (step S101b) according to the present example embodiment.

The estimation unit 103 repeats steps S101b_2 to S101b_4 for each of the pieces of image information PI_1 to PI_M being acquired in step S101a (step S101b_1; loop A).

The estimation unit 103 analyzes the image information PI_i, and, in a case where the image information PI_i includes one or more vehicles C, provides the vehicle ID to each of the one or more vehicles C, according to the vehicle ID being acquired from the ID acquisition apparatus 105a (step S101b_2).

Description is made on details of step S101b_2 while giving a case where the target region P_i at the time T2 is analyzed by using an analysis model being learned through machine learning, as an example. The analysis model is a model for analyzing the image information PI_i.

The time T2 is a time after the time T1. For example, the time T2 is a time at which the generation apparatus 101_i previously executes photographing. For example, the time T1 is a time at which the generation apparatus 101_i executes photographing immediately before the time T2.

Note that, the time T1 is not limited to a time immediately before the time T2, and may be a time at which the generation apparatus 101_i executes photographing before the time T2.

The estimation unit 103 inputs the image information PI_i at the time T2 and the image information PI_i at the time T1 to the analysis model. The image information PI_i at the time T2 is the image information PI_i including the photographing time T2. The image information PI_i at the time T1 is the image information PI_i including the photographing time T1.

According to those inputs, in a case where the image information PI_i at the time T2 includes one or more vehicles C, the analysis model outputs the vehicle ID of each of the vehicles C included in the image information PI_i.

Input data to the analysis model during learning are a plurality of pieces of image information acquired by photographing the road R. Typically, the plurality of pieces of image information is image information relating to successive frames or frames at a predetermined time interval in a moving image. During machine learning, the analysis model is subjected to supervised learning using training data. For example, the training data include information identifying each of the vehicles C included in the plurality of pieces of image information, as a correct answer.

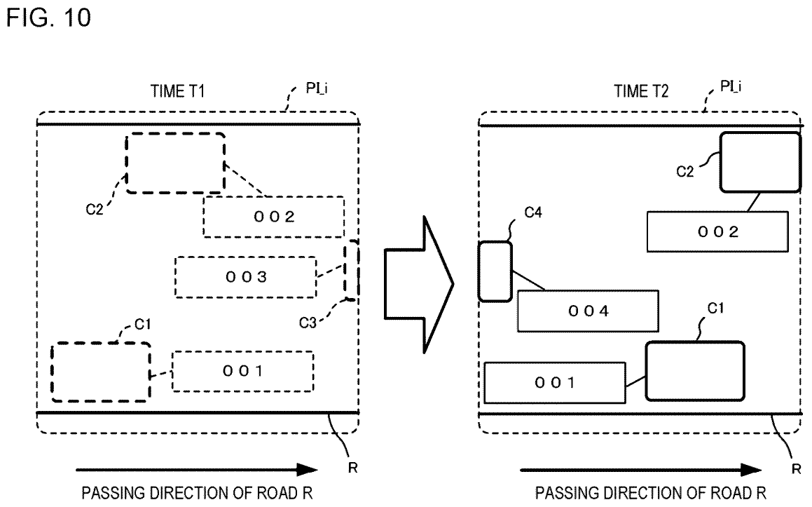

FIG. 10 is a diagram illustrating one example of a result of an analysis by the analysis model, where images included in the image information PI_i at the time T1 and the time T2, and the image information PI_i at the time T1 and the time T2 are used as input data. In the drawing, the vehicle C included in the image information PI_i at the time T2 is indicated with a solid line, and the vehicle C included in the image information PI_i at the time T1 is indicated with a dotted line.

In the example in the drawing, the image information PI_i at the time T1 includes vehicles C1 and C2, and a part of a vehicle C3. As a result of the analysis of the image information PI_i at the time T1, the vehicle ID of each of the vehicles C1 to C3 is determined as “001”, “002”, and “003”, respectively, in stated order.

For example, the analysis model decides whether the vehicle C is commonly shared in the image information PI_i at the time T1 and the time T2 (commonality of the vehicle C) by using a vehicle number included in the image.

As a result, it is assumed that the analysis model decides that, in the images in the image information PI_i at the time T1 and the time T2, the vehicle C located on a lower side in the drawing is commonly shared. Further, it is assumed that the analysis model decides that the vehicle C located on an upper side in the drawing is commonly shared. In other words, it is assumed that the analysis model decides that the image information PI_i at the time T2 includes the vehicle C1, and parts of the vehicles C2 and C4.

In such a case, as illustrated in the drawing, the analysis model provides the vehicles C1 and C2 included in the image information PI_i at the time T2 with the same vehicle IDs “001” and “002” as those of the vehicles C1 and C2 included in the image information PI_i at the time T1, respectively. For example, the estimation unit 103 provides the vehicle C4 included in the image information PI_i at the time T2 with the vehicle ID “004” being provided to the vehicle C4 as a result of an analysis of another piece of image information PI_i+1 at the time T1.

In this manner, the analysis model provides the same vehicle ID to the commonly-shared vehicle C.

Herein, the image information PI_M being associated with the target region P_M including the gate G1 includes the vehicle C that newly enters the road R through the gate G1. Thus, the estimation unit 103 can associate the vehicle C that newly enters the road R and the vehicle ID being acquired from the ID acquisition apparatus 105a with each other by using the image information PI_M.

For example, the estimation unit 103 associates the vehicle C that newly enters the road R and the vehicle ID with each other, based on the photographing time included in the image information PI_M and a time at which the ID acquisition apparatus 105a acquires the vehicle ID.

As a result, while passing through the road R, the vehicle C entering the road R is identified by using the vehicle ID being acquired by the ID acquisition apparatus 105a.

Note that, the estimation unit 103 may decide commonality of the vehicle C by using various publicly-known image processing techniques, specifically, by using a feature value of an image, or the like.

Refer back to FIG. 9.

The estimation unit 103 generates an analysis result 107, based on the result of the processing in step S101b_2 (step S101b_3).

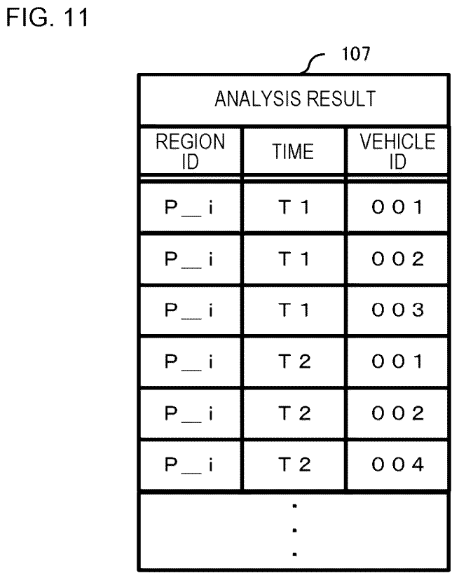

FIG. 11 is a diagram illustrating one example of the analysis result 107. The analysis result 107 is information in which a region ID, a time, and a vehicle ID are associated with each other.

The region ID is information for identifying the target region P_i associated with the image information PI_i being an analysis target. The time is a photographing time included in the image information PI_i being an analysis target.

The vehicle ID is a vehicle ID being applied in step S101b_2 by using the image information PI_i being an analysis target.

The analysis result 107 illustrated in the drawing includes a result of performing an analysis based on the image information PI_i at the time T1 and the time T2 described above.

Refer back to FIG. 9.

The estimation unit 103 stores the analysis result 107 being generated in step S101b_3 (step S101b_4). The estimation unit 103 executes steps S101b_2 to S101b_4 for each piece of the image information PI_1 to PI_M, and then returns to the estimation processing (step S101).

Refer back to FIG. 8.

The estimation unit 103 estimates the exhaust gas amount of the vehicle C on the road R, by using the analysis result 107 (step S101c).

In detail, for example, the estimation unit 103 estimates the exhaust gas amount of each of the vehicles C in each of the target regions P_1 to P_M and the exhaust gas amount of each of the vehicles C on the entire road, by using an estimation model. The estimation model is a model for estimating an exhaust gas amount. Information to be input to the estimation model is the analysis result 107.

### Example 1 of Estimation Model

The estimation model according to the present example embodiment is a model where it is assumed that an exhaust gas amount per unit time is changed according to a velocity of the vehicle C.

The exhaust gas amount (emission factor) per unit time according to the velocity may be decided as appropriate, but for example, it is decided based on an average of the exhaust gas amount at each velocity in a vehicle group configured by various vehicles C. The vehicle group may be configured by various types of vehicles C (details thereof are described later). Further, a composition ratio by each type of the vehicles C configuring the vehicle group may be the same as a composition ratio by each type of the vehicles C configuring the vehicle group passing through the road R.

The emission factor may be a value being acquired experimentally, based on a sensor (for example, a flow rate sensor or a CO₂ sensor) attached to the vehicle C, or may be a value being decided based on a value listed on a catalog of the vehicle C or the like.

Examples of the estimation model described above can include models represented by expressions (1) to (3).

$$\begin{matrix}[ Mathematical 1 ] & \\ Exhaust gas amount H = \sum {G}_{i} & Expression ( 1 )\end{matrix}$$

$$\begin{matrix}[ Mathematical 2 ] & \\ Exhaust gas amount {G}_{i} = K ( {V}_{i} ) \times {TL}_{i} & Expression ( 2 )\end{matrix}$$

$$\begin{matrix}[ Mathematical 3 ] & \\ Velocity {V}_{i} = \frac{{RL}_{i}}{{TL}_{i}} & Expression ( 3 )\end{matrix}$$

Herein, the exhaust gas amount H is an exhaust gas amount by each vehicle over the entire road R.

The exhaust gas amount Gi is the exhaust gas amount of the vehicle C in the target region P_i. In other words, the exhaust gas amount Gi is the exhaust gas amount of the vehicle C by each region.

K(Vi) is the emission factor. As described above, the emission factor according to the present example embodiment is the exhaust gas amount per unit time of the vehicle C according to the velocity.

Vi is the velocity of the vehicle.

TLi is a time length in which the vehicle C is present in the target region P_i. TLi can be acquired as a time difference between a time at which the vehicle C enters the target region P_i and a time at which the vehicle C exits from the target region P_i.

RLi is a length of the target region P_i along the passing direction of the road R.

At timing at which the vehicle C exits from the target region P_i, the estimation unit 103 acquires the exhaust gas amount Gi of each of the vehicles C in each of the target regions P_1 to P_M, by using the expressions (2) and (3). The estimation unit 103 generates an estimation result 108 including the exhaust gas amount Gi by each region.

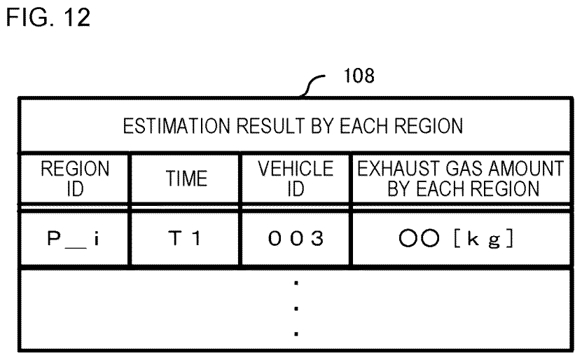

FIG. 12 is a diagram illustrating one example of the estimation result 108 by each region. The estimation result 108 is information in which a region ID, a time, a vehicle ID, and an exhaust gas amount by each region are associated with each other.

The region ID is information for identifying the target region P_i from which the vehicle C being identified by using the vehicle ID being associated with the region ID exits. The time is a time at which the vehicle C exits from the target region P_i. The exhaust gas amount by each region is the exhaust gas amount Gi of the vehicle C in the target region P_i.

In the example in FIG. 10, the vehicle C3 is not present in the target region P_i at the time T2, and hence exits from the target region P_i at the time T1. FIG. 12 includes an example of the estimation result 108 by each region, which is generated at timing at which the vehicle C3 exits from the target region P_i.

Further, for example, at timing at which the vehicle C exits from the road R, the estimation unit 103 acquires the exhaust gas amount H of the vehicle C by using the expression (1). For example, the timing at which the vehicle C exits from the road R is timing at which the vehicle C passes through the exit gate G2, is about to exit from a target region M, exits from the target region M, or the like.

The estimation unit 103 generates the estimation result 108 over the entire road, which includes the exhaust gas amount H of the vehicle C (target vehicle) exiting from the road R.

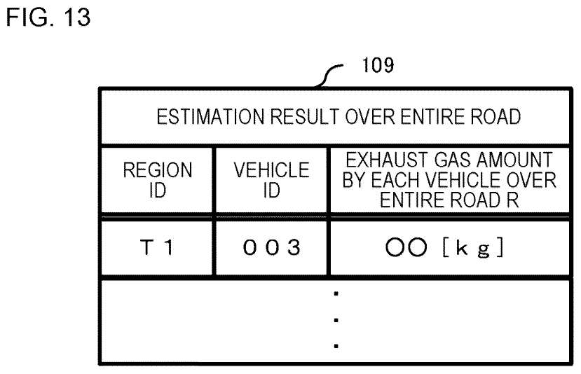

FIG. 13 is a diagram illustrating one example of an estimation result 109 over the entire road. The estimation result 109 is information in which a time, a vehicle ID, and the exhaust gas amount H by each vehicle over the entire road R are associated with each other.

The time is a time at which the vehicle C being identified by using the vehicle ID being associated with the time exits from the road R. The exhaust gas amount by each vehicle over the entire road R is the exhaust gas amount H of the vehicle C over the entire road R, the vehicle C being identified by using the vehicle ID being associated with the exhaust gas amount by each vehicle.

The drawing includes an example of the estimation result 109 over the entire road in a case where the vehicle C3 with the vehicle ID “003” exits from the road R at a time TX.

Refer back to FIG. 8.

The estimation unit 103 stores the estimation results 108 and 109 being generated in step S101c (step S101d), and returns to the traffic management processing.

Refer back to FIG. 7.

The decision unit 104 decides whether the target vehicle is present (S103). The target vehicle is the vehicle C passing through the exit gate G2.

In detail, for example, at timing at which the vehicle C passes through the exit gate G2, the settlement apparatus 105b performs communication wirelessly with the on-board device (omitted in illustration) of the vehicle C. Through the communication, the settlement apparatus 105b detects the target vehicle, and acquires the vehicle ID of the target vehicle from the on-board device.

In a case where the target vehicle is detected, the settlement apparatus 105b transmits a decision instruction for deciding the toll fee to the traffic management apparatus 102 via the network N. The decision instruction includes the vehicle ID of the target vehicle being acquired from the on-board device by the settlement apparatus 105b.

In a case where the decision instruction is not acquired from the settlement apparatus 105b, the decision unit 104 decides that the target vehicle is not present (step S103; No). The estimation unit 103 executes step S101 again.

In a case where the decision instruction is acquired from the settlement apparatus 105b, the decision unit 104 decides that the target vehicle is present (step S103; Yes). In this case, the decision unit 104 acquires, from the estimation unit 103, the estimation result 109 relating to the vehicle ID on the entire road, according to the vehicle ID included in the decision instruction.

The decision unit 104 decides the toll fee for the target vehicle to pass through the road R, based on the estimation result 109 over the entire road (step S102).

In detail, for example, the decision unit 104 acquires the exhaust gas amount of the target vehicle over the entire road R, based on the estimation result 109 over the entire road and the vehicle ID included in the decision instruction. According to a predetermined first decision rule, the decision unit 104 decides the toll fee for the target vehicle. The decision unit 104 generates fee information including the toll fee being decided. The fee information may further include the vehicle ID of the target vehicle.

The first decision rule is a rule for deciding a toll fee. The first decision rule defines a relationship between the exhaust gas amount H of the target vehicle over the entire road R and the toll fee, by using an equation, a table, or the like.

For example, the first decision rule defines a relationship where the toll fee is increased as the exhaust gas amount H of the target vehicle over the entire road R is larger. According to the first decision rule described above, the decision unit 104 decides the toll fee for the target vehicle in such a way that a price is set higher as the exhaust gas amount on the road R is larger.

In detail, for example, the first decision rule includes an exhaust gas amount serving as a certain criterion. In a case where the exhaust gas amount Gi of the target vehicle is more than the exhaust gas amount serving as the criterion, the decision unit 104 sets the toll fee for the target vehicle to a higher price. Further, in a case where the exhaust gas amount Gi of the target vehicle is less than the exhaust gas amount serving as the criterion, the decision unit 104 sets the toll fee for the target vehicle to a lower price. The exhaust gas amount serving as the criterion may be a fixed value or a variable value. For example, the exhaust gas amount serving as the criterion may be a value serving as a standard in a certain local area, a set target value, or the like.

The decision unit 104 transmits the fee information to the settlement apparatus 105b via the network N (step S104). The estimation unit 103 executes step S101 again.

The settlement apparatus 105b acquires the fee information being transmitted in step S104 from the decision unit 104 via the network N. The settlement apparatus 105b communicates wirelessly with the on-board device (omitted in illustration) of the target vehicle, and executes the settlement processing of the toll fee for the target vehicle according to the fee information.

The example embodiment 1 of the present invention is described above.

According to the present example embodiment, the traffic management apparatus 102 includes the estimation unit 103 and the decision unit 104. The estimation unit 103 estimates an exhaust gas amount of a vehicle. The decision unit 104 decides a toll fee for a target vehicle to pass through the road R, by using the exhaust gas amount being estimated.

With this, a user of the target vehicle can be motivated to reduce an exhaust gas amount. Therefore, an exhaust gas amount can be reduced.

The estimation unit 103 estimates the exhaust gas amount of the target vehicle on the road R.

With this, by using the exhaust gas amount of the target vehicle, the toll fee for the target vehicle to pass through the predetermined target region P can be decided. For example, the toll fee for the target vehicle with a smaller exhaust gas amount is set lower than the toll fee for the target vehicle with a larger exhaust gas amount, and thus a user of the target vehicle can be motivated to reduce an exhaust gas amount. Therefore, an exhaust gas amount can be reduced.

The decision unit 104 decides the toll fee for the target vehicle on the road R for which the exhaust gas amount of the target vehicle is estimated.

With this, a user of the target vehicle can be motivated to reduce an exhaust gas amount. Therefore, an exhaust gas amount can be reduced.

The decision unit 104 decides the toll fee for the target vehicle in such a way that a price is set higher as the exhaust gas amount being estimated is larger.

With this, a user of the target vehicle can be motivated to reduce an exhaust gas amount. Therefore, an exhaust gas amount can be reduced.

### Modification Example 1

In the example embodiment 1, description is made on an example in which each of the generation apparatuses 101_1 to 101_M is a photographing apparatus such as a camera. In a modification example 1, description is made on an example in which each of the generation apparatuses 101_1 to 101_M is an on-board device provided to the vehicle C. Note that, in the present modification example as well, one generation apparatus 101 may be provided.

The generation apparatuses 101_1 to 101_M according to the present modification example generate pieces of vehicle information CI_1 to CI_M relating to the vehicles C to which the generation apparatus 101_1 to 101_M are provided, in place of pieces of the image information PI_1 to PI_M according to the example embodiment 1. Each of the generation apparatuses 101_1 to 101_M transmits the vehicle information being generated to the traffic management apparatus 102 via the network N. The network N may include road-vehicle communication, vehicle-vehicle communication, or the like using a wireless technique.

For example, the vehicle information includes at least one of a vehicle number and a vehicle ID. The vehicle information may include one or a plurality of a vehicle model, a combustion type, an exhaust gas amount, a velocity of the vehicle C, an accelerator opening degree (acceleration), and the like.

The generation apparatus 101_i may be configured similarly to the traffic management apparatus 102 in a physical sense.

In the present modification example, the estimation unit 103 executes the analysis processing (step S101_b) similar to that in the example embodiment 1, by using the pieces of vehicle information CI_1 to CI_M in place of the pieces of image information PI_1 to PI_M according to the example embodiment 1. In other words, the estimation unit 103 according to the present modification example estimates the exhaust gas amount on the road R by using the vehicle information relating to each of one or more vehicles C being generated by the on-board device mounted on each of the one or more vehicles C.

However, in a case where the vehicle information includes the vehicle ID, a case where the vehicle information includes the vehicle number and the vehicle number is used as the vehicle ID, or the like, step S101B_2 may not be executed.

Then, the estimation unit 103 can generate the analysis result 107 similar to that in the example embodiment 1, by executing the analysis processing (step S101_b) using the pieces of vehicle information CI_1 to CI_M. Thus, the estimation unit 103 can generate the estimation results 108 and 109 similar to those in the example embodiment 1, by using the analysis result 107. Therefore, similarly to the example embodiment 1, the toll fee can be decided.

Note that, each of the generation apparatuses 101_1 to 101_M may include the photographing apparatus similar to that in the example embodiment 1 and the above-mentioned on-board device. Further, as described above, a sensor may be included. In other words, the estimation unit 103 may estimate an exhaust gas amount by using at least one of a carbon dioxide concentration on the road R, an image, and vehicle information being acquired from a vehicle. For example, the carbon dioxide concentration on the road R is a carbon dioxide concentration in each of the target regions P.

According to the present modification example, an advantageous effect similar to that in the example embodiment 1 can be achieved.

### Modification Example 1

In the example embodiment 1, description is made on an example in which the decision unit 104 decides the toll fee for the target vehicle on the road R for which the exhaust gas amount of the target vehicle is estimated. The decision unit 104 may decide a toll fee for a target vehicle on another road (omitted in illustration) through which the target vehicle passes after passing through the road R for which the exhaust gas amount of the target vehicle is estimated. The road through which the target vehicle passes after passing through the road R is a road connected to the road R, for example.

With this, a user of the target vehicle can also be motivated to reduce an exhaust gas amount. Therefore, an exhaust gas amount can be reduced.

### Example Embodiment 2

In an example embodiment 2, description is made on an example in which an exhaust gas amount of a vehicle C is estimated by further using a vehicle type.

In the present example embodiment, description is made on an example of a vehicle type classified according to a configuration of driving energy used in the vehicle C. For example, the vehicle type in this case includes an electric vehicle, a fuel cell vehicle (also referred to as a hydrogen vehicle.), a hybrid car, and an engine (internal combustion engine) vehicle.

An electric vehicle is a vehicle that charges a battery mounted on the vehicle from an external and uses power from the battery as driving energy. A fuel cell vehicle is a vehicle that uses electric power generated by hydrogen supplied from an external as driving energy.

A hybrid car is a vehicle that uses both fuel and electric power as driving energy. An engine (internal combustion engine) vehicle is a vehicle that uses only fuel, such as gasoline and diesel fuel, as driving energy.

In the present example embodiment, for the sake of simplification of description, description overlapping with the example embodiment 1 is omitted as appropriate.

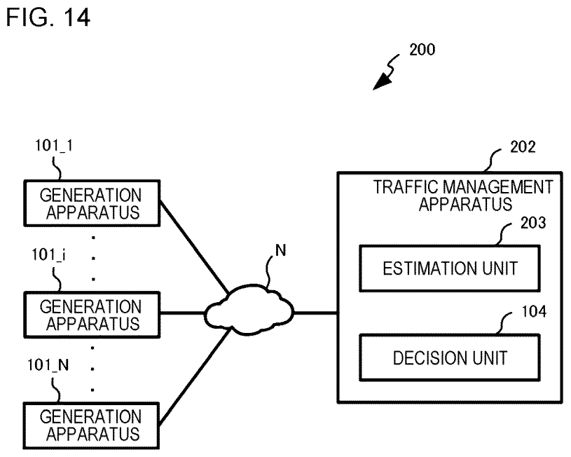

FIG. 14 is a diagram illustrating a configuration of a traffic management system 200 according to the example embodiment 2 of the present invention. The traffic management system 200 includes a traffic management apparatus 202 in place of the traffic management apparatus 102 according to the example embodiment 1. The traffic management apparatus 202 includes an estimation unit 203 in place of the estimation unit 103 according to the example embodiment 1. Except for those points, the traffic management system 200 may be configured similarly to the traffic management system 100 according to the example embodiment 1. Similarly to the example embodiment 1, the estimation unit 203 acquires image information PI_i from each of generation apparatuses 101_i via a network N. The estimation unit 203 estimates an exhaust gas amount on a road R, by using the image information PI_i being acquired from the generation apparatus 101_i.

The traffic management system 200 may be configured similarly to the traffic management system 100 according to the example embodiment 1 in a physical sense.

### (Operation of Traffic Management System 200)

Hereinafter, operation of the traffic management system 200 is described with reference to the drawings.

Generation processing according to the present example embodiment may be similar to that in the example embodiment 1.

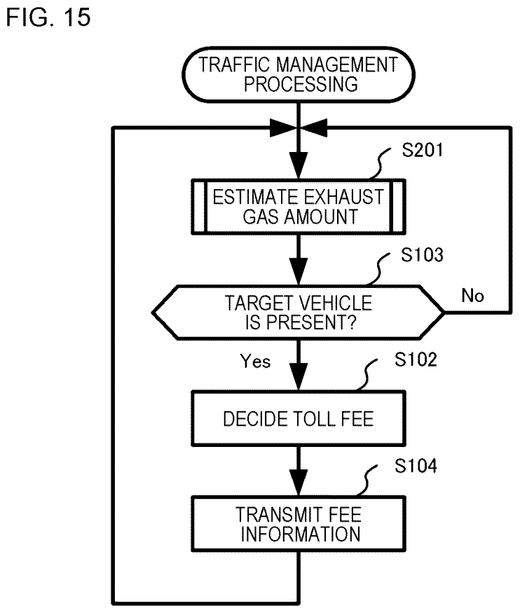

FIG. 15 is a flowchart illustrating one example of traffic management processing according to the example embodiment 2. The traffic management apparatus 202 executes the traffic management processing during the operation in a repeated manner. The traffic management processing according to the present example embodiment includes estimation processing (step S201) in place of the estimation processing (step S101) according to the example embodiment 1. Except for this point, the traffic management processing according to the present example embodiment may be similar to that in the example embodiment 1.

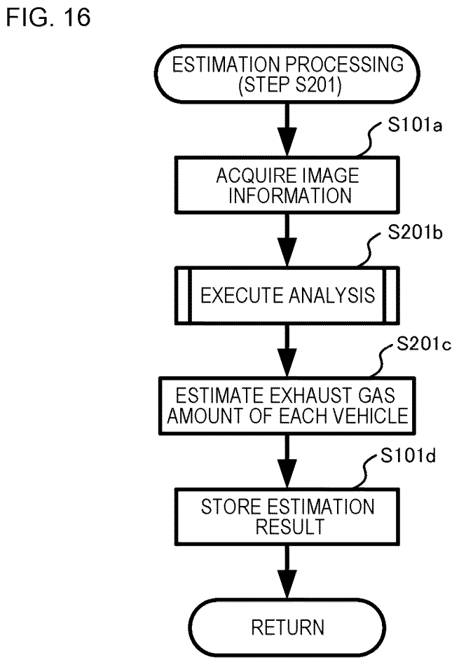

FIG. 16 is a flowchart illustrating one example of details of the estimation processing (step S201). The estimation processing (step S201) includes steps S201b to S201c in place of steps S101b to S101c according to the example embodiment 1. Except for this point, the estimation processing (step S201) according to the present example embodiment may be similar to that in the example embodiment 1.

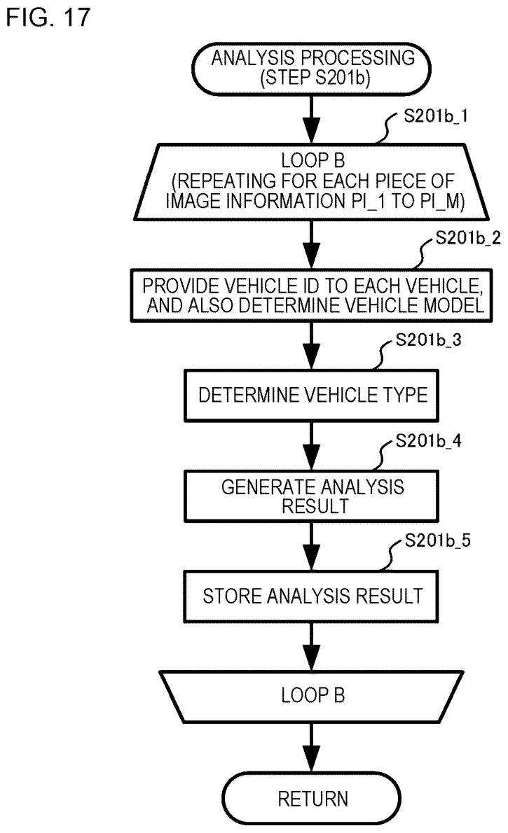

FIG. 17 is a flowchart illustrating one example of details of analysis processing (step S201b).

The estimation unit 103 repeats steps S201b_2 to S201b_5 for each of pieces of image information PI_1 to PI_M being acquired in step S101a (step S201b_1; loop B).

Similarly to the example embodiment 1, the estimation unit 203 analyzes the image information PI_i, and, in a case where the image information PI_i includes one or more vehicles C, provides a vehicle ID to each of the one or more vehicles C, according to the vehicle ID being acquired from an ID acquisition apparatus 105a. The estimation unit 203 further determines a vehicle model thereof (step S201b_2). In other words, the estimation unit 203 estimates a vehicle type, based on the image information PI_i.

Note that, as described in the modification example 1, the estimation unit 203 may acquire vehicle information, and, in such a case, the vehicle type may be estimated by using at least one of the vehicle model, a combustion type, and an exhaust gas amount.

An analysis model according to the present example embodiment is different from the analysis model according to the example embodiment 1 in that the vehicle model is output in addition to the vehicle ID.

In other words, the image information PI_i at a time T2 and a time T1 is input, and then the analysis model according to the present example embodiment outputs information in which the vehicle ID of each of the vehicles C included in the image information PI_i and the vehicle model are associated with each other.

Input data, during learning, to the analysis model according to the present example embodiment may be similar to that in the example embodiment 1. For example, in the analysis model according to the present example embodiment, training data during learning include the vehicle model of each of the vehicles C as a correct answer, in addition to information identifying each of the vehicles C included in a plurality of pieces of the image information.

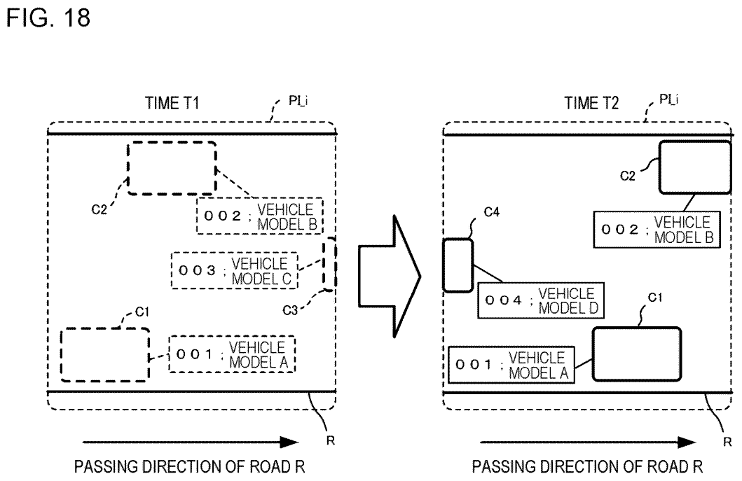

FIG. 18 is a diagram equivalent to FIG. 10. In other words, FIG. 18 is a diagram illustrating one example of a result of an analysis by the analysis model according to the present example embodiment, where images included in the image information PI_i at the time T1 and the time T2, and the image information PI_i at the time T1 and the time T2 are used as input data.

In the example in the drawing, the image information PI_i at the time T1 includes vehicles C1 and C2, and a part of a vehicle C3. As a result of the analysis of the image information PI_i at the time T1, the vehicle ID and the vehicle model of each of the vehicles C1 to C3 are determined as “001 and vehicle model A”, “002 and vehicle model B”, and “003 and vehicle model C”, respectively, in stated order.

Similarly to the example embodiment 1, the analysis model decides commonality of the vehicle C. As a result, similarly to the example embodiment 1, it is assumed that the analysis model decides that the image information PI_i at the time T2 includes the vehicle C1, and parts of the vehicles C2 and C4.

In such a case, as illustrated in the drawing, the analysis model provides the vehicles C1 and C2 included in the image information PI_i at the time T2 with the same vehicle IDs as the vehicles C1 and C2 included in the image information PI_i at the time T1, respectively. Further, for the vehicles C1 and C2 included in the image information PI_i at the time T1, the vehicle models “vehicle model A” and “vehicle model B” that are acquired based on the image information PI_i at the time T1 are determined respectively.

The estimation unit 203 provides the vehicle C4 included in the image information PI_i at the time T2 with the vehicle ID “004” being provided to the vehicle C4 as a result of an analysis of another piece of image information PI_i+1 at the time T1. Further, in the example in the drawing, the estimation unit 203 determines the vehicle model of the vehicle C with the vehicle ID “004” as a “vehicle model D”, according to output from the analysis model.

Note that, the estimation unit 203 may determine the vehicle model by using various publicly-known image processing techniques such as pattern matching.

Refer back to FIG. 17.

The estimation unit 203 determines the vehicle type of each of the vehicles C, based on the vehicle model being determined in step S201b_2 (step S201b_3).

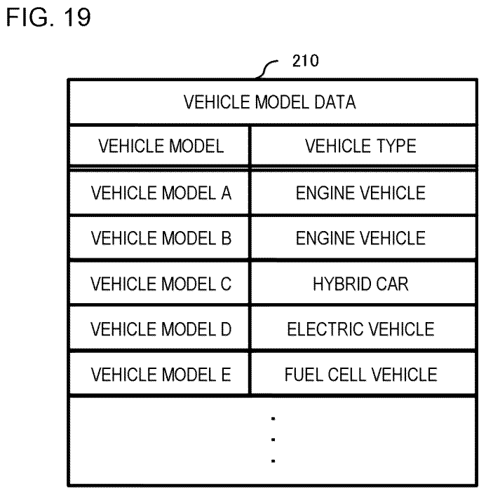

In detail, the estimation unit 203 determines the vehicle type by using vehicle model data 210 being stored in advance. The vehicle model data 210 are data in which the vehicle model and the vehicle type are associated with each other. FIG. 19 is a diagram illustrating one example of the vehicle model data 210.

Note that, a method of determining the vehicle type is not limited thereto. The analysis model described above may output the vehicle type in place of the vehicle model.

With the image information PI_i at the time T1 and the time T2 as an input, the analysis model in this case outputs information in which the vehicle ID of each of the vehicles C included in the image information PI_i and the vehicle type are associated with each other. Input data to the analysis model during learning may be similar to the input data to the analysis model during learning. The training data may include the vehicle type in place of the vehicle model.

Refer back to FIG. 17.

The estimation unit 203 generates an analysis result 207, based on the result of the processing in steps S201b_2 and S201b_3 (step S201b_4).

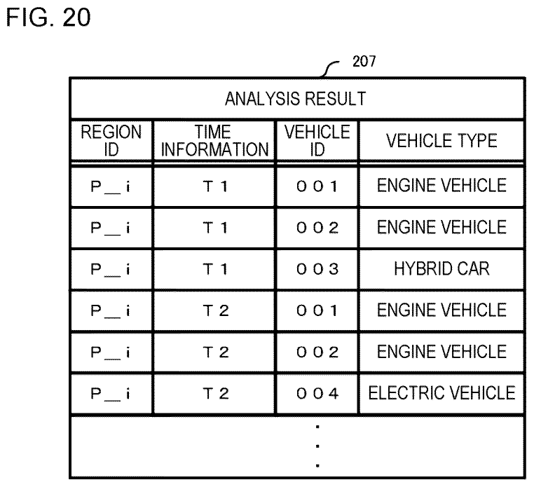

FIG. 20 is a diagram illustrating one example of the analysis result 207. The analysis result 207 is information in which a region ID, a time, a vehicle ID, and a vehicle type are associated with each other.

The vehicle type is a vehicle type being determined in step S101b_3 for the vehicle C being identified by using the vehicle ID being associated with the vehicle type.

The analysis result 207 illustrated in the drawing includes a result of performing an analysis based on the image information PI_i at the time T1 and the time T2 described above.

Refer back to FIG. 17.

The estimation unit 203 stores the analysis result 207 being generated in step S201b_4 (step S201b_5). The estimation unit 203 executes steps S201b_2 to S201b_5 for each piece of the image information PI_1 to PI_M, and then returns to the estimation processing (step S201).

Note that, the estimation unit 103 may determine the vehicle model by using various publicly-known image processing techniques such as pattern matching.

Refer back to FIG. 16.

The estimation unit 203 estimates the exhaust gas amount of the vehicle C on the road R, by using the analysis result 207 (step S201c).

Similarly to the example embodiment 1, the estimation unit 203 estimates the exhaust gas amount of each of the vehicles C in each of target regions P_1 to P_M and an exhaust gas amount H of each of the vehicles C over the entire road R, by using an estimation model for estimating an exhaust gas amount. Information to be input to the estimation model is the analysis result 207.

In the present example embodiment, the estimation model being used by the estimation unit 203 is different from that in the example embodiment 1. The estimation model according to the present example embodiment is described.

### Example 2 of Estimation Model

The estimation model according to the present example embodiment includes a model for each vehicle type. The estimation model is a model where it is assumed that an exhaust gas amount per unit time of each of the vehicles C is constant for each vehicle type. In other words, the model for each vehicle type according to the present example embodiment represents an exhaust gas amount per unit time as a constant number defined for each vehicle type.

The exhaust gas amount (emission factor) per unit time for each vehicle model may be decided as appropriate, but, for example, it is decided based on an exhaust gas amount from the vehicle C of each type while traveling at a predetermined velocity. The predetermined velocity may be decided as appropriate, but, for example, it is an average travel velocity on the road R. The emission factor may be a value being acquired experimentally, based on a sensor (for example, a flow rate sensor or a CO₂ sensor) attached to the vehicle C, or may be a value being decided based on a value listed on a catalog of the vehicle C or the like.

Examples of the estimation model described above can include models represented by the expression (1) given above and an expression (4) given below.

$$\begin{matrix}[ Mathematical 4 ] & \\ Exhaust gas amount {G}_{i} = K ( {M}_{i} ) \times {TL}_{i} & Expression ( 4 )\end{matrix}$$

K(Mi) is the emission factor. The emission factor according to the present example embodiment is an exhaust gas amount per unit time for each vehicle type.

Mi represents the vehicle type.

At timing at which the vehicle C exits from the target region P_i, the estimation unit 203 acquires the exhaust gas amount Gi of each of the vehicles C in each of the target regions P_1 to P_M, by using the expression (4). The estimation unit 203 generates an estimation result 108 for each region (see FIG. 12) similar to that in the example embodiment 1.

Further, similarly to the example embodiment 1, at timing at which the vehicle C exits from a target region M, in other words, timing at which the vehicle C exits from the road R, the estimation unit 203 acquires the exhaust gas amount H of the vehicle C by using the expression (1). Similarly to the example embodiment 1, the estimation unit 203 generates an estimation result 109 over the entire road.

The processing after step S101d is similar to that in the example embodiment 1, and hence description therefor is omitted.

The example embodiment 2 of the present invention is described above.

According to the present example embodiment, the estimation unit 203 estimates an exhaust gas amount on the road R by using a type of the vehicle C passing through the road R.

With this, the exhaust gas amount on the road R can be estimated more accurately. Thus, a user of a target vehicle can be motivated more strongly to reduce an exhaust gas amount. Therefore, an exhaust gas amount can be reduced more.

### Modification Example 3

In the example embodiment 2, description is made on an example in which a vehicle type includes an electric vehicle, a fuel cell vehicle (also referred to as a hydrogen vehicle.), a hybrid car, and an engine (internal combustion engine) vehicle. However, the vehicle type is not limited thereto.

The vehicle type classified according to a configuration of driving energy may be classified into further segments, or a plurality of the vehicle types exemplified herein may be collectively regarded as one. For example, an engine vehicle may be classified further into a gasoline car, a diesel car, and the like. Further, for example, an electric vehicle and a fuel cell vehicle may be collectively classified into one category as a vehicle that only uses electric power as driving energy. Furthermore, a criterion for the vehicle type classification is not limited to a configuration of driving energy. For example, the vehicle type may be a vehicle model.

With this, an advantageous effect similar to that in the example embodiment 2 can also be achieved.

### Modification Example 4: Example 3 of Estimation Model

An estimation model according to the present modification example is similar to the estimation model according to the example embodiment 2 in that a plurality of models for each vehicle type are included. The estimation model according to the present modification example represents an exhaust gas amount (emission factor) per unit time for each vehicle type as a function where a travel state is a variable.

For example, a function of defining the emission factor may be a function representing an average CO₂ emission amount of the vehicle C by each vehicle type, and may be decided experimentally, based on a sensor (for example, a flow rate sensor or a CO₂ sensor) attached to the vehicle C, or may be decided based on a value listed on a catalog of the vehicle C or the like.

Examples of the estimation model described above can include models represented by the expression (1) given above and an expression (5) given below.

$$\begin{matrix}[ Mathematical 5 ] & \\ Exhaust gas amount {G}_{i} = K ( {M}_{i} , RSi ) \times {TL}_{i} & Expression ( 5 )\end{matrix}$$

K(X, Y) is the emission factor. As described above, the emission factor according to the present modification example is an exhaust gas amount per unit time for each vehicle type.

K(X, Y) includes X being the vehicle type and Y being a travel state as a variable. Thus, the emission factor is an exhaust gas amount per unit time of the vehicle C in a case where the vehicle type is X and the travel state is Y. In the present example embodiment, as described above, K(X, Y) is a function decided for each vehicle type X, where the travel state Y including a travel velocity, acceleration, an idling stop state, and a load weight as a variable.

RSi represents the travel state. For example, RSi is a vector amount including one or more values, such as a travel velocity, acceleration, an idling stop state, and a load weight, as a component.

The idling stop state indicates whether the vehicle C being stopped is in idling stop. For example, as a value indicating the idling stop state, a predetermined value may be set in association with whether idling occurs. Specifically, for example, a value “1” may indicate idling, and a value “0” may indicate non-idling.

For example, the travel state may be acquired by the estimation unit 203 in the analysis processing (step S201b). For example, in step S201b_2, the estimation unit 203 acquires some or all of a travel velocity, acceleration, an idling stop state, and a load weight, based on an analysis of the image information PI_i.

For example, the estimation unit 203 acquires each of a travel velocity and acceleration, based on a position change of the vehicle C and a time difference that are included in the plurality of pieces of image information PI_i including different photographing times.

For example, the estimation unit 203 acquires a stop idling state, based on a result of comparison between vibration of the vehicle C and a predetermined threshold value. For example, in a case where the vibration of the vehicle C is equal to or greater than the threshold value, the estimation unit 203 decides that idling stop does not occur. In a case where the vibration of the vehicle C is less than the threshold value, the estimation unit 203 decides that idling stop occurs.

For example, the estimation unit 203 acquires a load weight, based on a sinking amount of the vehicle C. The estimation unit 203 may acquire the sinking amount of the vehicle C by comparing a vehicle height of the vehicle C, which is acquired by using an analysis of the image information PI_i being an analysis target, and a standard vehicle height of a vehicle, which is the same vehicle model as the vehicle C, with each other.

Further, for example, the vehicle information may include one or more of a travel velocity, acceleration, an idling stop state, and a load weight. In a case where the vehicle C includes a weight sensor, an on-board device can generate the vehicle information including a load weight being acquired by using the weight sensor.

In such a case, in step S201b_2, the estimation unit 203 may acquire a travel velocity, acceleration, an idling stop state, and a load weight, based on an analysis of the vehicle information.

According to the present example embodiment, the estimation unit 203 estimates an exhaust gas amount on the road R by using a travel state of the vehicle C passing through the road R.

With this, the exhaust gas amount on the road R can be estimated more accurately. Thus, a user of a target vehicle can be motivated more strongly to reduce an exhaust gas amount. Therefore, an exhaust gas amount can be reduced more.

### Example Embodiment 3

In the example embodiments 1 and 2, description is made on an example in which settlement is made at timing of passing through an exit gate G2, in other words, an example of post-payment where a toll fee is paid after passing through a road R. However, the toll fee may be pre-paid. In the present example embodiment, description is made on an example in which settlement is made at timing of passing through an entrance gate G2.

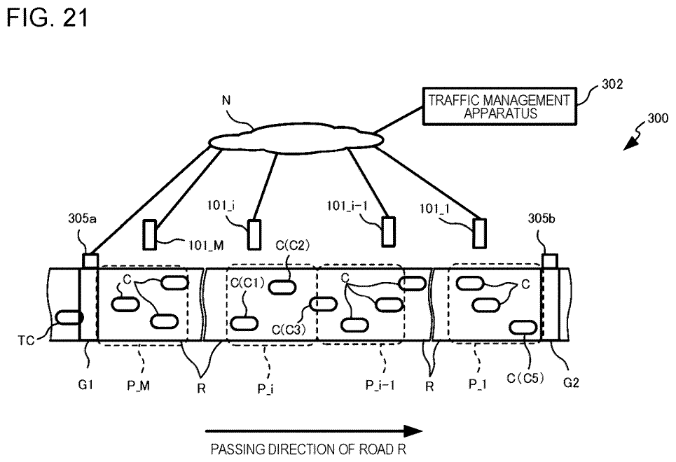

FIG. 21 is a diagram illustrating a configuration of a traffic management system 300 according to an example embodiment 3 of the present invention. The traffic management system 300 includes a plurality of generation apparatuses 101_1 to 101_M similar to those in the example embodiment 1. Further, the traffic management system 300 includes a traffic management apparatus 302 in place of the traffic management apparatus 102 according to the example embodiment 1. Further, the traffic management system 300 includes a settlement apparatus 305a and another settlement apparatus 305b.

Each of the settlement apparatus 305a and the settlement apparatus 305b is an apparatus installed on the road R. The settlement apparatus 305a is installed at the entrance gate G1. The settlement apparatus 305b is installed at the exit gate G2.

Each of the settlement apparatus 305a and the settlement apparatus 305b is connected to the traffic management apparatus 302 via the network N. Thus, the settlement apparatus 305a and the traffic management apparatus 302 can transmit and receive information mutually. The settlement apparatus 305b and the traffic management apparatus 302 can transmit and receive information mutually.

The settlement apparatus 305a is an apparatus that detects a vehicle C entering the road R and also settles a toll fee for the vehicle C being detected, as a target vehicle, to pass through the road R.

The settlement apparatus 305a communicates wirelessly with an on-board device (omitted in illustration) mounted on the vehicle C. For example, the on-board device is an apparatus that configures an ETC together with the settlement apparatuses 305a and 305b, and the like.

Through the communication with the on-board device, the settlement apparatus 305a detects the vehicle C entering the road R, and also acquires a vehicle ID from the on-board device. The settlement apparatus 305a transmits, to the traffic management apparatus 102 via the network N, a first decision instruction including the vehicle ID of the target vehicle, which is acquired from the on-board device. In response to the first decision instruction, the settlement apparatus 305a acquires the toll fee for the target vehicle from the traffic management apparatus 302. The settlement apparatus 305a settles the toll fee for the target vehicle, according to the toll fee being decided by the traffic management apparatus 302.

The settlement apparatus 305b is an apparatus that detects the vehicle C exiting from the road R and also discounts the toll fee for the vehicle C being detected as a target vehicle. In the present example embodiment, description is made on an example in which the toll fee is discounted by refunding at least part of the pre-paid toll fee. A method of discounting a toll fee is not limited thereto, and the refund may be made by issuing a coupon, issuing a discount ticket that can be used for a next travel on the road R, or the like.

Similarly to the settlement apparatus 305a, the settlement apparatus 305b communicates wirelessly with the on-board device (omitted in illustration) mounted on the vehicle C.

Through the communication with the on-board device, the settlement apparatus 305b detects the vehicle C entering the road R, and also acquires the vehicle ID from the on-board device. The settlement apparatus 305b transmits, to the traffic management apparatus 102 via the network N, a second decision instruction including the vehicle ID of the target vehicle, which is acquired from the on-board device. In response to the second decision instruction, the settlement apparatus 305b acquires the toll fee for the target vehicle from the traffic management apparatus 302. The settlement apparatus 305b settles the toll fee for the target vehicle, according to the toll fee being decided by the traffic management apparatus 302.

The traffic management apparatus 302 decides the toll fee for a target vehicle to pass through the road R for the vehicle C, as the target vehicle, passing through the entrance gate G1 to which the settlement apparatus 305a is provided. Further, the traffic management apparatus 302 decides the toll fee for a target vehicle to pass through the road R for the vehicle C, as the target vehicle, passing through the exit gate G2 to which the settlement apparatus 305b is provided.

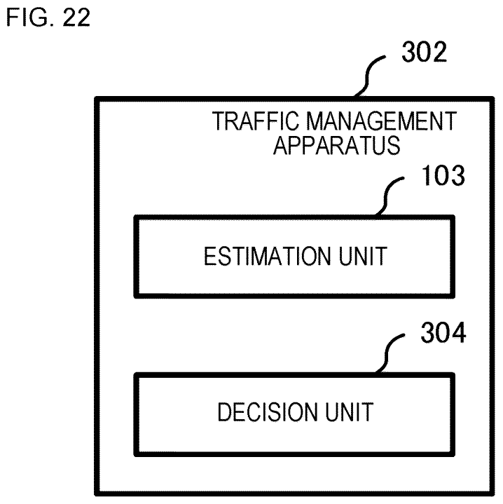

FIG. 22 is a diagram illustrating a functional configuration of the traffic management apparatus 302 according to the present example embodiment. The traffic management apparatus 302 includes an estimation unit 103 similar to that in the example embodiment 1 and a decision unit 304 in place of the decision unit 104 according to the example embodiment 1. Similarly to the example embodiment 1, the estimation unit 103 estimates an exhaust gas amount of the target vehicle on the road R. Further, the estimation unit 103 estimates the exhaust gas amount of one or more vehicles C in a target region P, which pass through the road R before the target vehicle.

The decision unit 304 decides the toll fee for the target vehicle to pass through the road R, by using the exhaust gas amount being estimated by the estimation unit 103.

In the present example embodiment, as described above, the settlement apparatus 305a settles the toll fee at timing at which the vehicle C enters the road R. Thus, the target vehicle is the vehicle C passing through the entrance gate G1 to which the settlement apparatus 305a is provided. In other words, in the present example embodiment, the vehicle entering the road R is regarded as the target vehicle.

Further, as described above, the settlement apparatus 305b settles the refund of the toll fee at timing at which the vehicle C exits from the road R. Thus, the target vehicle is also the vehicle C passing through the exit gate G2 to which the settlement apparatus 305b is provided. In other words, in the present example embodiment, at timing of passing through the exit gate G2, each of the vehicles C passing through the road R is also regarded as the target vehicle.

### (Physical Configuration of Traffic Management System 300)

The traffic management apparatus 302 may be configured similarly to the traffic management apparatus 102 according to the example embodiment 1 in a physical sense. Each of the settlement apparatuses 305a and 305b may be configured similarly to the settlement apparatus 105b according to the example embodiment 1 in a physical sense.

### (Operation of Traffic Management System 300)

Hereinafter, operation of the traffic management system 300 is described with reference to the drawings.

Generation processing according to the present example embodiment may be similar to that in the example embodiment 1.

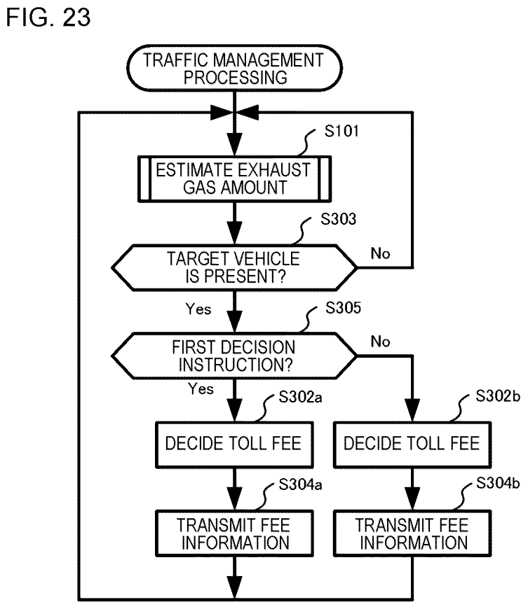

FIG. 23 is a flowchart illustrating one example of the traffic management processing according to the present example embodiment. The traffic management apparatus 302 executes the traffic management processing during the operation in a repeated manner.

The estimation unit 103 executes step S101 similar to that in the example embodiment 1.

The decision unit 304 decides whether the target vehicle is present (S303). As described above, the target vehicle is a vehicle passing through the entrance gate G1 and the vehicle C passing through the exit gate G2.

In a case where neither the first decision instruction nor the second decision instruction is acquired, the decision unit 304 decides that the target vehicle is not present (step S303; No).

In this case, the estimation unit 103 executes step S101 again.

In a case where any of the first decision instruction and the second decision instruction is acquired, the decision unit 304 decides that the target vehicle is present (step S303; Yes). The decision unit 304 decides whether a decision instruction being acquired is the first decision instruction (step S305).

(Decision Processing in Case where First Start Instruction is Acquired)

In a case where it is decided that the first decision instruction is acquired (step S305; Yes), the decision unit 304 decides a toll fee for the target vehicle to pass through the road R, based on an estimation result 108 by each region (step S302a).

In detail, for example, the decision unit 304 acquires a current exhaust gas amount of the vehicle C over the entire road R, based on the estimation result 108 by each region. The current exhaust gas amount of the vehicle C over the entire road R is a total of the exhaust gas amount of the vehicle C passing through the road R. For example, the decision unit 304 acquires the current exhaust gas amount of the vehicle C over the entire road by adding up the exhaust gas amount by each region, which is included in the estimation result 108 by each region that includes a current time (alternatively, a predetermined time range from the current time).

According to a predetermined second decision rule, the decision unit 304 decides the toll fee for the target vehicle. The decision unit 304 generates fee information including the toll fee being decided. The fee information may further include the vehicle ID of the target vehicle.

The second decision rule is a rule for deciding a toll fee. The second decision rule defines a relationship between the current exhaust gas amount over the entire road R and the toll fee, by using an equation, a table, or the like.

For example, the second decision rule defines a relationship where the toll fee is increased as the current exhaust gas amount of the vehicle C over the entire road R is larger. According to the second decision rule described above, a decision unit 104 decides the toll fee for the target vehicle in such a way that a price is set higher as the exhaust gas amount on the road R is larger.

The target vehicle is the vehicle C being about to enter the road R. The decision unit 304 decides the toll fee for the target vehicle, based on the exhaust gas amount of the vehicle C that previously passes through the road R. In other words, the decision unit 304 decides the toll fee for the target vehicle, by using the exhaust gas amount of one or more vehicles on the road R, the one or more vehicles passing through the road R before the target vehicle.

The decision unit 304 transmits the fee information to each of the settlement apparatus 305a and the settlement apparatus 305b via the network N (step S304a). The estimation unit 103 executes step S101 again.

The settlement apparatus 305a acquires the fee information from the decision unit 304 via the network N. The settlement apparatus 305a communicates wirelessly with the on-board device (omitted in illustration) of the target vehicle, and executes settlement processing of the toll fee for the target vehicle according to the fee information.

(Decision Processing in Case where Second Start Instruction is Acquired)

In a case where it is decided that the first decision instruction is not acquired, (step S305; No), the decision unit 304 refers to an estimation result 109 over the entire road, and acquires an exhaust gas amount H of the vehicle ID, which is included in the second decision instruction, in other words, the vehicle ID of the target vehicle, over the entire road R. According to the first decision rule similar to that in the example embodiment 1, the decision unit 304 decides the toll fee for the target vehicle (step S302b).

In step S302b, the decision unit 304 generates the fee information including the toll fee being decided. The fee information may further include the vehicle ID of the target vehicle.

The decision unit 304 transmits the fee information to the settlement apparatus 305b via the network N (step S304b). The estimation unit 103 executes step S101 again.

The settlement apparatus 305b acquires the fee information being transmitted in each of step S304a and step S304b. It is assumed that, for the same target vehicle (in other words, the target vehicle with the same vehicle ID), the toll fee included in the fee information being transmitted in step S304a is a “toll fee M1”. It is assumed that the toll fee included in the fee information being transmitted in step S304b is a “toll fee M2”.

In a case where the toll fee M1 is higher than the toll fee M2, the settlement apparatus 305b decides a different therebetween as a refund amount. The settlement apparatus 305b settles the refund of the toll fee for the target vehicle, according to the refund amount being decided.

In other words, the decision unit 304 according to the present example embodiment decides the toll fee for the target vehicle, by further using the exhaust gas amount of the target vehicle on the road R.

As described above, the toll fee M1 is a toll fee being decided based on the exhaust gas amount of the vehicle C on the road R, which passes through the road R before the target vehicle. The toll fee M2 is a toll fee being decided based on a result from a case where the target vehicle actually passes through the road R. With this refund settlement, the refund can be settled for the target vehicle to be estimated to pass through the road R by a small exhaust gas amount. Thus, a user of the target vehicle can be motivated to reduce an exhaust gas amount.

The example embodiment 3 of the present invention is described above.

According to the present example embodiment, the estimation unit 103 estimates an exhaust gas amounts of the one or more vehicles C on the road R, which pass through the road R before a target vehicle.

With this, a toll fee for the target vehicle to pass through the road R can be decided by using the exhaust gas amount of the vehicle passing through the road R before the target vehicle. Thus, a user of the target vehicle can be motivated to pass through the road R with a smaller exhaust gas amount. In general, at a measurement location where an exhaust gas amount is small, traffic of the vehicle C is smooth, and the exhaust gas amount from the vehicle C is often reduced. Therefore, an exhaust gas amount can be reduced.

According to the present example embodiment, the estimation unit 103 further estimates the exhaust gas amount of the target vehicle in a road section. The decision unit 304 decides the toll fee for the target vehicle by using both the exhaust gas amount of the one or more vehicles C on the road R, which pass through the road R before the target vehicle, and the exhaust gas amount of the target vehicle on the road R.

With this, the toll fee is decided by using the exhaust gas amount of the vehicle passing through the road R before the target vehicle, and thus a user of the target vehicle can be motivated to pass through the road R with a smaller exhaust gas amount. Further, even in a case where the target vehicle passes through the road R where an exhaust gas amount is relatively large, the toll fee is decided by using the exhaust gas amount of the target vehicle, and thus a user of the target vehicle can be motivated to reduce an exhaust gas amount of the target vehicle. Therefore, an exhaust gas amount can be reduced.

According to the present example embodiment, processing for discounting at least part of the toll fee being decided is executed based on the exhaust gas amount of the target vehicle on the road R.

With this, as described above, a user of the target vehicle can be motivated to reduce an exhaust gas amount. Therefore, an exhaust gas amount can be reduced.

### Modification Example 5

In the example embodiment 3, description is made on an example in which the decision unit 304 executes the processing for discounting a toll fee being decided, based on an exhaust gas amount of a target vehicle on the road R. The decision unit 304 may execute the processing for discounting the toll fee being decided, based on at least one of the exhaust gas amount of the target vehicle on the road R and travel information indicating a travel state of the target vehicle on the road R.

As described above, the travel state is a travel velocity, acceleration, an idling stop state, a load weight, and the like. The travel information may include some or all of a travel velocity, acceleration, an idling stop state, a load weight, and the like.

As described in the modification example 4, the travel state can be acquired based on one or both of image information PI_i and vehicle information.

In the present modification example, an advantageous effect similar to that in the example embodiment 3 can also be achieved.

### Modification Example 6

The decision units 104 and 304 may decide a toll fee for a target vehicle by further using absorber information relating to a carbon dioxide absorber (CO₂ absorber) in the periphery of a road section. The CO₂ absorber is a plant such as a tree, a paint and a material that include a function of absorbing CO₂, and the like, and such a paint and a material are provided on a wall surface of a building, for example. For example, information relating to the CO₂ absorber includes at least one of a position at which the CO₂ absorber is installed, an area where the CO₂ absorber is installed or the number thereof, a value indicating a CO₂ absorption capacity of the CO₂ absorber being installed, and the like. For example, the decision units 104 and 304 may acquire the absorber information from an external apparatus via the network N.

For example, the decision units 104 and 304 adjusts, by further using the absorber information, a toll fee being decided by using an exhaust gas amount on a road. Examples of an adjustment method include lowering a toll fee on the road R where an amount of CO₂ absorbers is greater than a reference value, raising a toll fee in a road section where an amount of CO₂ absorbers is less than a reference value, and the like.

According to the present modification example, a user of the target vehicle can be motivated to pass through the road R where a CO₂ absorber absorbs a larger amount of CO₂. Therefore, an exhaust gas amount can be reduced.

While the example embodiments and the modification examples of the present invention are described above with reference to the drawings, those are merely examples of the present invention, and various configurations other than those described above may be adopted.

Further, in a plurality of flowcharts used in the description given above, a plurality of steps (pieces of processing) are described in order, but the execution order of the steps executed in each of the example embodiments is not limited to the described order. In each of the example embodiments, the order of the illustrated steps may be changed without interfering with the contents. Further, the example embodiments and the modification examples described above may be combined with each other within a range where the contents do not conflict with each other

The whole or a part of the example embodiments described above can be described as, but not limited to, the following supplementary notes.

1.

A traffic management apparatus including:
an estimation unit that estimates an exhaust gas amount of a vehicle; and
a decision unit that decides a toll fee for a target vehicle to pass through a predetermined road section, by using the exhaust gas amount being estimated.
   2.

The traffic management apparatus according to supplementary note 1, wherein
the estimation unit estimates an exhaust gas amount of one or more vehicles in the road section, the one or more vehicles passing through the road section before the target vehicle.
   3.

The traffic management apparatus according to supplementary note 2, wherein
the estimation unit further estimates an exhaust gas amount of the target vehicle in the road section, and
the decision unit decides the toll fee for the target vehicle by using both an exhaust gas amount of one or more vehicles in the road section, the one or more vehicles passing through the road section before the target vehicle and the exhaust gas amount of the target vehicle in the road section.
   4.

The traffic management apparatus according to supplementary note 3, wherein
the decision unit decides the toll fee for the target vehicle by further using information relating to a carbon dioxide absorber in a periphery of the road section.
   5.

The traffic management apparatus according to supplementary note 1, wherein
the estimation unit estimates an exhaust gas amount of the target vehicle in the road section.
   6.

The traffic management apparatus according to supplementary note 5, wherein
the decision unit decides the toll fee for the target vehicle in the road section in which an exhaust gas amount of the target vehicle is estimated.
   7.

The traffic management apparatus according to supplementary note 5, wherein
the decision unit decides the toll fee for the target vehicle in another road section through which the target vehicle passes after passing through the road section in which an exhaust gas amount of the target vehicle is estimated.
   8.

The traffic management apparatus according to any one of supplementary notes 1 to 4, wherein
the estimation unit estimates the exhaust gas amount by using at least one of a carbon dioxide concentration in the road section, an image, and vehicle information being acquired from a vehicle.
   9.

The traffic management apparatus according to any one of supplementary notes 1 to 8, wherein
the decision unit further executes processing for discounting at least a part of the toll fee being decided, based on at least one of an exhaust gas amount of the target vehicle in the road section and travel information indicating a travel state of the target vehicle in the road section.
   10.

The traffic management apparatus according to any one of supplementary notes 1 to 9, wherein
the decision unit decides the toll fee for the target vehicle in such a way that a price is set higher as the exhaust gas amount being estimated is larger.
   11.

A traffic management system including:
the traffic management apparatus according to any one of supplementary notes 1 to 10; and
a generation apparatus that generates information for estimating an exhaust gas amount of the vehicle.
   12.

A traffic management method including,
by a computer:
   estimating an exhaust gas amount of a vehicle; and
   deciding a toll fee for a target vehicle to pass through a predetermined road section, by using the exhaust gas amount being estimated.
      13.

A storage medium storing a program for causing a computer to execute:
estimating an exhaust gas amount of a vehicle; and
deciding a toll fee for a target vehicle to pass through a predetermined road section, by using the exhaust gas amount being estimated.
   11.

A program for causing a computer to execute:
estimating an exhaust gas amount of a vehicle; and
deciding a toll fee for a target vehicle to pass through a predetermined road section, by using the exhaust gas amount being estimated.

### REFERENCE SIGNS LIST

100, 200, 300 Traffic management system
101 Generation apparatus
102, 202, 302 Traffic management apparatus
103, 203 Estimation unit
104, 304 Decision unit
105a ID acquisition apparatus
105b, 305a, 305b Settlement apparatus
107, 207 Analysis result
108, 109, 208 Estimation result
210 Vehicle model data
G1 Entrance gate
G2 Exit gate

What is claimed is:

1. A traffic management apparatus comprising:
at least one memory configured to store instructions; and
at least one processor configured to execute the instructions to:
estimate an exhaust gas amount of a vehicle; and
decide a toll fee for a target vehicle to pass through a predetermined road section, by using the exhaust gas amount being estimated.

2. The traffic management apparatus according to claim 1, wherein
the exhaust gas amount being estimated includes an exhaust gas amount of one or more vehicles in the road section, the one or more vehicles passing through the road section before the target vehicle.

3. The traffic management apparatus according to claim 2, wherein
the exhaust gas amount being estimated further includes an exhaust gas amount of the target vehicle in the road section, and
the toll fee for the target vehicle is decided by using both an exhaust gas amount of one or more vehicles in the road section, the one or more vehicles passing through the road section before the target vehicle, and an exhaust gas amount of the target vehicle in the road section.

4. The traffic management apparatus according to claim 3, wherein
the toll fee for the target vehicle is decided by further using information relating to a carbon dioxide absorber in a periphery of the road section.

5. The traffic management apparatus according to claim 1, wherein
the exhaust gas amount being estimated includes an exhaust gas amount of the target vehicle in the road section.

6. The traffic management apparatus according to claim 5, wherein
deciding the toll fee for the target vehicle includes deciding a toll fee for the target vehicle in the road section in which an exhaust gas amount of the target vehicle is estimated.

7. The traffic management apparatus according to claim 5, wherein
deciding the toll fee for the target vehicle includes deciding a toll fee for the target vehicle in another road section through which the target vehicle passes after passing through the road section in which an exhaust gas amount of the target vehicle is estimated.

8. The traffic management apparatus according to claim 1, wherein
the exhaust gas amount is estimated by using at least one of a carbon dioxide concentration in the road section, an image, and vehicle information being acquired from a vehicle.

9. The traffic management apparatus according to claim 1, wherein
at least one processor configured to execute the instructions to:
execute processing for discounting at least a part of the toll fee being decided, based on at least one of an exhaust gas amount of the target vehicle in the road section and travel information indicating a travel state of the target vehicle in the road section.

10. The traffic management apparatus according to claim 1, wherein
the toll fee for the target vehicle is decided in such a way that a price is set higher as the exhaust gas amount being estimated is larger.

11. A traffic management system comprising:
the traffic management apparatus according to claim 1; and
a generation apparatus that generates information for estimating an exhaust gas amount of the vehicle.

12. A traffic management method comprising,
by a computer:
estimating an exhaust gas amount of a vehicle; and
deciding a toll fee for a target vehicle to pass through a predetermined road section, by using the exhaust gas amount being estimated.

13. A non-transitory computer readable medium storing a program for causing a computer to execute:
estimating an exhaust gas amount of a vehicle; and
deciding a toll fee for a target vehicle to pass through a predetermined road section, by using the exhaust gas amount being estimated.
